(19) United States
(12) Patent Application Publication
(10) Pub. No.: US 2022/0158199 A1
(43) Pub. Date: May 19, 2022

(54) GAS DIFFUSION LAYER FOR A FUEL CELL, AND FUEL CELL

(71) Applicant: Robert Bosch GmbH, Stuttgart (DE)

(72) Inventors: Silvan Hippchen, Sersheim (DE); Harald Bauer, Ehningen (DE); Juergen Hackenberg, Sachsenheim (DE)

(21) Appl. No.: 17/438,533

(22) PCT Filed: Feb. 19, 2020
(86) PCT No.: PCT/EP2020/054374

§ 371 Date: Sep. 13, 2021

(30) Foreign Application Priority Data
Mar. 13, 2019 (DE) 10 2019 203 373.3

(51) Int. Cl. H01M 4/88; H01M 4/86; H01M 8/1004

(52) U.S. Cl. CPC H01M 4/8807; H01M 4/8668; H01M 2008/1095; H01M 4/8673; H01M 8/1004

(57) ABSTRACT

The invention relates to a gas diffusion layer (1) for a fuel cell (3), comprising a composite material (5) that contains electrically conducting particles (7), a binder and fibers (9), preferably carbon fibers, the particles (7) and the fibers (9) being present in the composite material (5) in the form of a mixture. The invention also relates to a fuel cell and to a method for producing the gas diffusion layer.

### BACKGROUND OF THE INVENTION

The invention relates to a gas diffusion layer for a fuel cell, comprising a composite material. The invention also relates to a fuel cell which comprises the gas diffusion layer and also a process for producing the gas diffusion layer.

A fuel cell is an electrochemical cell which converts the chemical reaction energy of a continuously supplied fuel and an oxidant into electric energy. A fuel cell is thus an electrochemical energy converter. In known fuel cells, hydrogen (H₂) and oxygen (O₂), in particular, are converted into water (H₂O), electric energy and heat.

An electrolyzer is an electrochemical energy converter which splits water (H₂O) by means of electric energy into hydrogen (H₂) and oxygen (O₂).

Inter alia, proton exchange membrane (PEM) fuel cells are known; these are also referred to as polymer electrolyte fuel cells. Anion exchange membranes are also known, both for fuel cells and for electrolyzers. Proton exchange membrane fuel cells have a centrally arranged membrane which is able to conduct protons, i.e. hydrogen ions. The oxidant, in particular atmospheric oxygen, is spatially separated thereby from the fuel, in particular hydrogen.

Proton exchange membrane fuel cells additionally have an anode and a cathode. The fuel is fed in at the anode of the fuel cell and catalytically oxidized to protons with release of electrons. The protons go through the membrane to the cathode. The electrons released are conducted out from the fuel cell and flow via an external circuit to the cathode.

The oxidant is fed in at the cathode of the fuel cell and reacts by uptake of electrons from the external circuit and protons, which have travelled through the membrane to the cathode, to form water. The water formed in this way is discharged from the fuel cell. The net reaction is:

O₂+4H⁺4e⁻→2H₂O

There is thus an electric potential between the anode and the cathode of the fuel cell. To increase the electric potential, a plurality of fuel cells can be arranged mechanically one after the other to form a fuel cell stack and be electrically connected in series.

To obtain uniform distribution of the fuel at the anode and uniform distribution of the oxidant at the cathode, bipolar plates are provided. The bipolar plates have, for example, channel-like structures to distribute the fuel and the oxidant at the electrodes. The channel-like structures additionally serve to conduct away the water formed in the reaction. The bipolar plates can also have structures for conducting a cooling liquid through the fuel cell in order to remove heat.

On the cathode side of the PEM fuel cell, oxygen has to be transported perpendicularly to the membrane surface into the reaction zone at the membrane and the water formed has to be removed. This is usually achieved through an open pore system, for example a particulate porous layer (microporous layer, 1VIPL). At the same time, the pore system has to ensure electrical contact between the catalyst at the membrane and the bipolar plate.

In general, a pore system and an electrically conductive support structure, which also satisfy mechanical requirements resulting from the contact pressure for contacting and sealing, are combined. The particulate porous layer having a pore system (MPL) and the support structure (gas diffusion backbone, GDB) are also referred to collectively as gas diffusion layer. The materials participating in the reaction have to be introduced and carried away uniformly and distributed uniformly over the area parallel to the membrane. In order to achieve uniform distribution, a certain degree of pressure drop is accepted, with the local reaction rate being pressure-dependent and decreasing with local pressure differences.

To introduce and carry away materials participating in the reaction, use is frequently made of structures which have larger pores with increasing distance from the membrane. In general, a PEM fuel cell is constructed with a very fine, usually hydrophilic catalyst-containing layer composed of carbon particles being applied as electrode to both sides of the membrane. The composite of an electrode layer on each side of the membrane and the membrane is referred to as electrode-membrane-electrode assembly (EME). The pore size here is about 15 nm. On the EME, there is on each side a gas diffusion layer which usually comprises a microporous layer (MPL) and a support structure (gas diffusion backbone, GDB), with the microporous layer being arranged on the membrane side and the support structure being arranged on the side of the gas diffusion layer facing away from the membrane. The microporous layer, which is usually formed by carbon particles for the electrical conductivity and Teflon particles as chemically resistant binder system having poor wettability for liquid water, generally has a pore size in the range from 0.06 μm to 1 μm. The support structure is frequently configured as woven carbon fabric or carbon fibers joined in a paper-like fashion with pores in the range from 20 μm to 200 μm.

On the side of the gas diffusion layer facing away from the membrane, there are then, in the layer structure, structured gas channels and plates composed of graphite or metal, which are also referred to as gas distributor structures. By means of webs between the gas channels, the gas diffusion layer is pressed by the bipolar plates onto both sides of the membrane and thus contacts the catalyst layer both electrically and thermally. The width of gas channels and webs is typically from 0.2 mm to 2 mm, so that the distance from web middle to web middle is in the range from 0.4 to 4 mm.

U.S. Pat. No. 9,160,020 describes metal foams and expanded metal structures which are used as gas distributor structures. However, the suitability of metal foams is restricted since they can damage thin gas diffusion layers or microporous layers and also the membrane of the fuel cell.

As gas diffusion layers, carbon fiber papers or woven carbon mats are in particular known from the molding of carbon fiber-reinforced plastics, and these are coated with a microporous layer.

US 2004/0512588 describes gas diffusion layers which are pressed from coarse particles and have thicknesses of about 400 μm, which are used with and without a microporous layer.

The exclusive use of a microporous layer as gas diffusion layer or the exclusive use of a fiber nonwoven, which represents a support structure, as gas diffusion layer is known from Kotaka et al., Investigation of Interfacial Water Transport in the Gas Diffusion Media by Neutron Radiography, ECS Transactions, 64(3), pages 839-851, 2014; here, the use of the fiber nonwoven alone led to increased accumulation of water in the cell. Hiroshi et al., Application of a self-supporting microporous layer to gas diffusion layers of proton exchange membrane fuel cells, Journal of Power Sources 342, 2017, pages 393-404, also relates to the use of a microporous layer or a support layer as gas diffusion layer.

Inhomogeneous electrical and thermal contacts and also the accumulation of product water, which can be due to irregular and relatively widely separated carbon fibers with correspondingly large spaces inbetween, have been described for the exclusive use of carbon fiber paper as gas diffusion layer.

Furthermore, US 2004/0152588 discloses the production of composite materials comprising a polymer matrix, and U.S. Pat. No. 9,325,022 describes the production of gas diffusion layers. Electrode films are usually produced by means of slurry processes, melt extrusion or largely solvent-free rolling processes.

In general, deteriorations in performance are observed in the scaling-up of fuel cells, which is attributable to local inhomogeneities.

### SUMMARY OF THE INVENTION

A gas diffusion layer for a fuel cell, which comprises a composite material containing electrically conductive particles, a binder and fibers, preferably carbon fibers, wherein the particles and the fibers are present mixed in the composite material, is proposed. The gas diffusion layer can also be used in other electrochemical energy converters, for example in an electrolyzer.

The gas diffusion layer of the invention can be considered to be a fiber-reinforced, particle-based porous gas diffusion layer.

The gas diffusion layer preferably has precisely one layer and the one layer comprises the composite material. In particular, the gas diffusion layer is made up of one layer of the composite material. The gas diffusion layer more preferably consists of the composite material.

The properties of the support structure described in the prior art and of the microporous layer are combined in the composite material. The composite material thus contains the electrically conductive particles and also the fibers, which are not spatially separated from one another but rather are present in mixed form.

The gas diffusion layer preferably does not comprise any support structure (GDL).

The fibers preferably have a length L of at least 0.2 mm, preferably at least 2 mm. The length L is further preferably not more than 12 mm. The length L is usually understood as the largest possible spatial extension of a fiber.

The fibers preferably have a diameter Df of from 5 μm to 15 μm, in particular from 6 μm to 12 μm.

The carbon fibers are, in particular, short carbon fibers, e.g. of the type SIGRAFIL from SGL Group. Short carbon fibers are obtainable, in particular, by cutting of continuous fibers.

The electrically conductive particles can, compared to the fibers, be described as geometrically round. The electrically conductive particles preferably have a ratio of length to width to height of from 1:1:1 to 10:10:1. The electrically conductive particles preferably have, in particular, a round shape, a potato-like shape or a platelet shape. For the present purposes, a round shape is understood to have an approximate ratio of length to width to height of 1:1:1, a potato-like shape an approximate ratio of 5:3:2 and a platelet shape an approximate ratio of 10:10:1.

The gas diffusion layer preferably has a thickness D of from 10 μm to 300 μm, more preferably from 20 μm to 150 μm.

The composite material preferably contains from 1% by weight to 20% by weight, preferably from 2% by weight to 10% by weight, of a first binder, in particular polyvinylidene fluoride (PVDF), from 0% by weight to 20% by weight, preferably from 1% by weight to 10% by weight, of a second binder, in particular polytetrafluoroethylene (PTFE), from 1% by weight to 50% by weight, preferably from 5% by weight to 20% by weight, of the fibers, from 0% by weight to 96% by weight, preferably from 10% by weight to 50% by weight, of the electrically conductive particles having an average diameter dm of from 0.5 μm to 50 μm and from 2% by weight to 98% by weight, preferably from 10% by weight to 78% by weight, of the electrically conductive particles having an average diameter dm of less than 0.5 μm.

Furthermore, the composite material preferably has elastic properties, in particular an elastic deformation of up to 10%.

The composite material is preferably porous and can be processed to give thin layers or films.

A fuel cell comprising a gas diffusion layer according to the invention, wherein the fuel cell is, in particular, a polymer electrolyte fuel cell (PEMFC), is also proposed. The fuel cell preferably comprises two gas diffusion layers according to the invention.

The gas diffusion layer is, in particular, arranged between a bipolar plate and an electrode-membrane-electrode assembly in the fuel cell.

In one possible embodiment of the invention, the fuel cell comprises a gas distributor structure having a surface, where the surface has raised regions for conducting gas and neighboring raised regions are at a spacing A from one another. The spacing A is, in particular, understood to be a width of a flow channel between the raised regions. The length L of the fibers of the composite material is preferably at least twice as long, preferably at least three times long and in particular not more than fifty times as long, as the spacing A.

The fuel cell also preferably does not comprise any support structure (GDB).

Furthermore, the invention proposes a process for producing a gas diffusion layer, comprising the following steps:
a. Production of a first mixture containing the first fiber, a solvent and an additive,
b. Application of the first mixture to the electrically conductive particles and the fibers, preferably using a fluidized bed, so as to form a second mixture,
c. Compounding of the second mixture and extrusion or rolling-out of a film from the second mixture.

The additive can be conductive carbon black, conductive graphite, vitreous carbon or mixtures thereof. The vitreous carbon preferably has an average diameter of from 1 μm to 10 μm and can be porous or gastight. The additive can also contain the electrically conductive particles having an average diameter dm of from 0.5 μm to 50 μm or consist of these.

The composite material makes a thin configuration of a gas diffusion layer possible, with both a uniform distribution of the materials participating in the reaction and electrical and thermal contacting, and also a satisfactory mechanical stability, being ensured. A multilayer structure of a gas diffusion layer can be dispensed with, as a result of which the construction height of the fuel cell and also of the fuel cell stack can be reduced.

Possible banking-up of product in the fuel cell is reduced and higher current densities can be achieved.

In addition, a more homogeneous temperature and pressure distribution can be achieved and the fuel cell can be pressed at a higher pressure, which allows a higher gas pressure in the cell and reduces the contact resistances at the transition to the catalyst and the bipolar plate. The gas diffusion layer of the invention offers reliable mechanical support for the membrane opposite the bipolar plate, without damaging the membrane.

Furthermore, the flexurally stiff, thin structure of the gas diffusion layer of the invention assists the assembly process, in particular positioning of the gas diffusion layer. The gas diffusion layer also offers a tolerance equalization during assembly when the composite material has elastic properties.

Furthermore, the gas diffusion layer of the invention can form a self-supporting film having a low surface roughness, so that the gas diffusion layer can be coated directly with a catalyst layer and a membrane (direct membrane deposition, DMD). The gas diffusion layer of the invention is stable and the fibers are embedded in the electrically conductive particles, so that fibers projecting from the surface and thus damage to the membrane are avoided.

The gas diffusion layer can also be structured further by embossing or printing and the flow pattern on the bipolar plate side can be influenced thereby.

### BRIEF DESCRIPTION OF THE DRAWINGS

Embodiments of the invention will be explained further with the aid of the drawings and the following description.

The drawings show:

FIG. 1 a fuel cell stack,

FIG. 2 a fuel cell having a gas diffusion layer according to the prior art and

FIG. 3 a fuel cell having a gas diffusion layer according to the invention.

### DETAILED DESCRIPTION

In the following description of embodiments of the invention, identical or similar elements are denoted by identical reference numerals, with a repeated description of these elements in individual cases being dispensed with. The figures depict the subject matter of the invention only schematically.

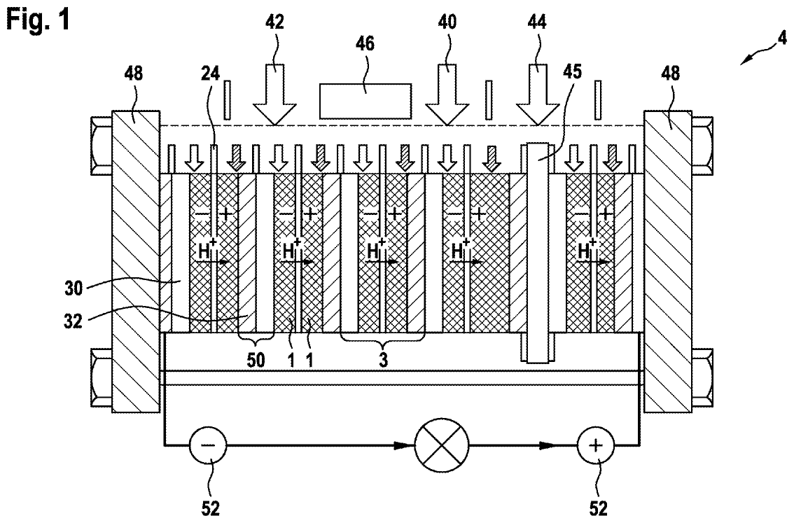

FIG. 1 shows a schematic depiction of a fuel cell stack 4 comprising a plurality of fuel cells 3. Each fuel cell 3 comprises a membrane 24, two gas diffusion layers 1, an anode 30 and a cathode 32. The individual fuel cells 3 are separated from one another by bipolar plates 50, which can comprise a cooling plate 45.

The fuel cell stack 4, to which hydrogen 40 and oxygen 42 and also a cooling medium 44 are supplied, is closed off by two end plates 48 and has current collectors 52. The various feed conduits are separated from one another by seals 46.

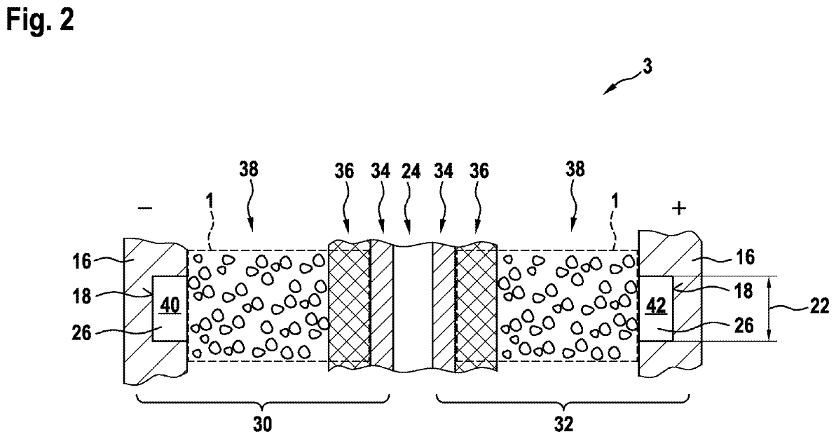

FIG. 2 shows a schematic depiction of a fuel cell 3 which comprises a gas diffusion layer 1 according to the prior art.

The fuel cell 3 comprises a membrane 24 on both sides of which a catalyst layer 34 is arranged. Next to the catalyst layer 34, there is in each case a gas diffusion layer 1, which in each case is made up of a support structure 38 and a microporous layer 36, both on the side of the anode 30 and on the side of the cathode 32. The support structure 38 has a larger pore size than the microporous layer 36 and is arranged on the side of the gas diffusion layer 1 facing away from the membrane 24. The gas diffusion layers 1 are each enclosed by a gas distributor structure 16 through which hydrogen 40 or oxygen 42 is supplied to the gas diffusion layers 1. The gas distributor structures 16 have surfaces 18 having raised regions 20. The raised regions 20 are at a spacing A 22 from one another, as a result of which gas feed channels 26 are formed.

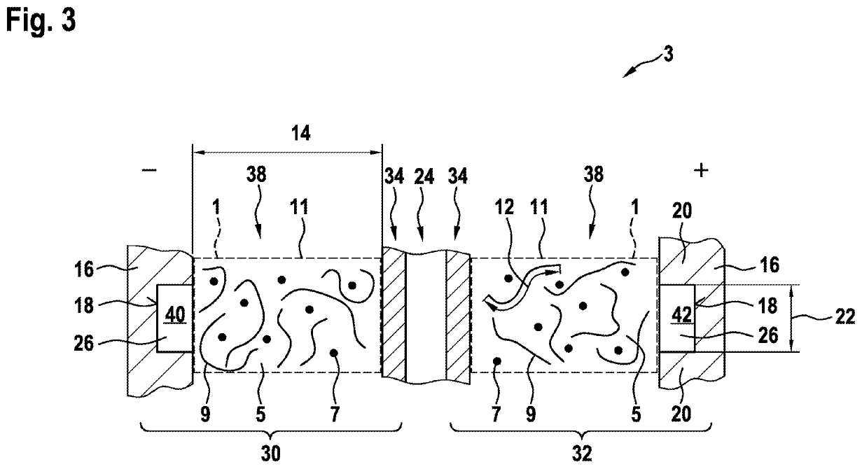

FIG. 3 shows a fuel cell 3 comprising a gas diffusion layer 1 according to the invention. The fuel cell 3 corresponds substantially to the fuel cell 3 depicted in FIG. 2, with the difference that in FIG. 3 the gas diffusion layers 1 are configured according to the invention. The gas diffusion layers 1 consist of only one layer 11 which extends from the catalyst layer 34 to the surface 18 of the gas distributor structure 16. The gas diffusion layers 1 are made up of a composite material 5 which contains electrically conductive particles 7 and fibers 9. The fibers 9 have a length L 12 which is at least twice as long as the spacing A 22 between the raised regions 20 of the gas distributor structures 16. Furthermore, the gas diffusion layers 1 have a thickness D 14.

The gas diffusion layers 1 as shown in FIG. 3, which are made up of the composite material 5, replace in each case the support structures 38 and the microporous layers 36 which are depicted in FIG. 2.

The invention is not restricted to the working examples described here and the aspects emphasized therein. Rather, many modifications which are of the kind that a person skilled in the art would routinely make are possible within the scope defined by the claims.

1. A gas diffusion layer (1) for a fuel cell (3), comprising a composite material (5) containing electrically conductive particles (7), a binder and fibers (9), wherein the particles (7) and the fibers (9) are present as a mixture in the composite material (5).

2. The gas diffusion layer (1) as claimed in claim 1, wherein the gas diffusion layer (1) has precisely one layer (11) and the one layer (11) comprises the composite material (⁵).

3. The gas diffusion layer (1) as claimed claim 1, wherein the fibers (9) have a length L (12) of at least 0.2 mm.

4. The gas diffusion layer (1) as claimed in claim 1, wherein the fibers (9) have a diameter Df of from 5 μm to 15 μm.

5. The gas diffusion layer (1) as claimed in claim 1, wherein the composite material (5) has elastic properties.

6. The gas diffusion layer (1) as claimed in claim 1, wherein the gas diffusion layer (1) has a thickness D (14) of from 10 μm to 300 μm.

7. The gas diffusion layer (1) as claimed in claim 1, wherein the composite material (5) contains
from 1% by weight to 20% by weight of a first binder,
from 0% by weight to 20% by weight of a second binder,
from 1% by weight to 50% by weight of the fibers (9),
from 0% by weight to 96% by weight of the electrically conductive particles (7) having an average diameter dm of from 0.5 μm to 50 μm and
from 2% by weight to 98% by weight of the electrically conductive particles (7) having an average diameter dm of less than 0.5 μm.

8. A fuel cell (3) comprising a gas diffusion layer (1) as claimed in claim 1, wherein the fuel cell (3) is a polymer electrolyte fuel cell (PEMFC).

9. The fuel cell (3) as claimed in claim 8, wherein the fuel cell (3) comprises a gas distributor structure (16) having a surface (18) and the surface (18) has raised regions (20) for conducting gas and neighboring raised regions (20) are at a spacing A (22) from one another,
where the length L (12) of the fibers (9) is at least twice as long as the spacing A (22).

10. A process for producing a gas diffusion layer (1) as claimed in claim 1, comprising the following steps:
a. Production of a first mixture containing the first fiber, a solvent and an additive, b. Application of the first mixture to the electrically conductive particles (7) and the fibers (9) so as to form a second mixture, c. Compounding of the second mixture and extrusion or rolling-out of a film from the second mixture.

11. A gas diffusion layer (1) for a fuel cell (3), comprising a composite material (5) containing electrically conductive particles (7), a binder and carbon fibers (9), wherein the particles (7) and the fibers (9) are present as a mixture in the composite material (5).

12. The gas diffusion layer (1) as claimed claim 1, wherein the fibers (9) have a length L (12) of at least 2 mm.

13. The gas diffusion layer (1) as claimed claim 1, wherein the fibers (9) have a length L (12) of at least 2 mm and not more than 12 mm.

14. The gas diffusion layer (1) as claimed in claim 1, wherein the gas diffusion layer (1) has a thickness D (14) of from 20 μm to 150 μm.

15. The gas diffusion layer (1) as claimed in claim 1, wherein the composite material (5) contains from 2% by weight to 10% by weight of a first binder, which is polyvinylidene fluoride (PVDF), from 1% by weight to 10% by weight of a second binder, which is polytetrafluoroethylene (PTFE), from 5% by weight to 20% by weight of the fibers (9), from 10% by weight to 50% by weight of the electrically conductive particles (7) having an average diameter dm of from 0.5 μm to 50 μm and 10% by weight to 78% by weight of the electrically conductive particles (7) having an average diameter dm of less than 0.5 μm.

16. The fuel cell (3) as claimed in claim 8, wherein the fuel cell (3) comprises a gas distributor structure (16) having a surface (18) and the surface (18) has raised regions (20) for conducting gas and neighboring raised regions (20) are at a spacing A (22) from one another, where the length L (12) of the fibers (9) is at least three times as long and not more than fifty times as long as the spacing A (22).

17. A process for producing a gas diffusion layer (1) as claimed in claim 1, comprising the following steps:
a. Production of a first mixture containing the first fiber, a solvent and an additive, b. Application of the first mixture to the electrically conductive particles (7) and the fibers (9) using a fluidized bed so as to form a second mixture, c. Compounding of the second mixture and extrusion or rolling-out of a film from the second mixture.
